(19) United States
(12) Patent Application Publication
(10) Pub. No.: US 2005/0018216 A1
(43) Pub. Date: Jan. 27, 2005

(54) Apparatus and method to advertise to the consumer based off a digital image

(75) Inventors: Eric Lawrence Barsness, Pine Island, MN (US); Cary Lee Bates, Rochester, MN (US); Mahdad Majd, Rochester, MN (US); John Matthew Santosuosso, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: International Business Machines Corporation, Armonk, NY (US)

(21) Appl. No.: 10/624,852

(22) Filed: Jul. 22, 2003

(51) Int. Cl. G06F 15/00

(52) U.S. Cl. 358/1.6; 358/1.14

(57) ABSTRACT

The present invention provides an apparatus, method and program product for analyzing a digital image for consumer identifying characteristics, and generating advertisements specifically to the consumer based on the identifying characteristics of the digital image. The analysis of the digital image may involve object recognition, text recognition and/or metadata analysis of a selected digital image. The present invention may be implemented, for example, within a photo kiosk or digital minilab. The generated advertisements may utilize a variety of media, including on-screen displays on the photo kiosk, a customized coupon, or a photo jacket insert.

### RELATED APPLICATIONS

The present invention is related to Ser. No. 09/977,649, filed Oct. 15, 2001, entitled, “Apparatus and Method for Recognizing Objects in a Digital Image and for Performing One or More Predetermined Functions According to Recognized Objects”, also owned by the assignee of the present invention.

### FIELD OF THE INVENTION

The present invention relates generally to an apparatus and method for analyzing digital images, and more specifically relates to an apparatus and method for analyzing a digital image for consumer identifying characteristics, and generating advertisements specifically targeted to the consumer based on the identifying characteristics within the digital image.

### BACKGROUND OF THE INVENTION

Photography has been popular for many decades as a way to preserve the past in the form of photographs. Modern developments in photography have added digital cameras that generate an image in electronic form instead of using film. Most digital cameras include an array of charge-coupled devices (CCDs) or other sensors that each record the color and intensity of light that strikes it when a digital photograph is taken. Each CCD or sensor typically makes up one “pixel” in a bit-map of thousands or millions of pixels that collectively define a digital image.

One advantage of digital photography is the ability to store digital images in electronic form, usually as files. This allows traditional file management techniques to be used to store and retrieve digital images. In the prior art, digital cameras typically record digital images on a recordable media, such as a floppy disk, or other memory media that is made of flash electronically erasable programmable read-only memory (Flash EEPROM). Current examples of memory media include: compact flash cards, smart media cards, memory sticks, XD cards, and SD cards.

Many owners of digital cameras print photographs from their digital cameras via their home computers. The digital images stored in the camera may be loaded into a computer, either by placing the recordable media in a reader coupled to the computer, or by coupling the digital camera to the computer via a suitable cable and transferring all the images from the digital camera to the computer's hard drive. Once the digital images are in the computer, the consumer may use photo editing software on the computer to edit the images, and eventually print the images to a printer connected to the computer.

While printing photographs on a consumer's home computer/printer may seem convenient at first glance, there are also significant shortcomings to such an approach. Printing photographic quality prints with a home printer can be a very slow process. In fact, some home printers may require as much as 10 minutes in order to print a single, photo-quality print. Also, even at the best print quality, few printers can approach the quality of prints available from commercial photo processing facilities. The cost of supplies (e.g., quality inks and photo papers) can make the cost per print of home generated photo prints to be significantly higher than commercial photo processing facilities. Finally, a consumer has to maintain an adequate stock of expensive supplies.

As a result, there has been explosive growth in retail based digital processing solutions. Two such solutions are photo kiosks and digital minilabs. Photo kiosks are public consumer-operated stations that allow consumers to work with their own photos, while digital minilabs, located behind the retail counter, process film and print from a digital file. Consumers typically bring memory media from their digital cameras to the photo kiosks/digital minilabs at a retail location, or send their image files to the digital minilabs via the Internet.

A recent report entitled “Retail Digital Photofinishing Market Outlook” from Infotrends Research Group, Inc. predicts strong growth for digital photo kiosks over the next five years. Currently, there are approximately 26,000 photo kiosks in North America, and it is predicted that this number will rise to almost 150,000 by 2006—a compound growth rate of 34% annually. Most consumers today use photo kiosks for making reprints or enlargements from their snapshots. They are attracted to the convenience and customization offered by kiosks, compared to the traditional approach of handling negatives and waiting days for the results. Now new features and functions are being introduced into kiosks, boosting other uses. New features include kiosks aimed specifically at digital camera consumers who want immediate prints, kiosks that accept credit cards, and thus can be located virtually anywhere, kiosks that use alternative types of print engines such as inkjet; and kiosks that have no print engines, but send photos directly to the Web or to a remote high speed print engine, such as a digital minilab.

Strong growth is also predicted in Infotrends' report for digital minilabs. Infotrends predicts growth from 4% market penetration against current film minilabs in 2000, to 70% penetration by 2006. Infotrends predicts that increasingly, digital camera consumers will be replacing film consumers in seeking one-hour printing of their photos, and this will drive the growth in minilabs.

Given the rising popularity of digital photo kiosks and digital minilabs with consumers, retailers are recognizing the advantages to offering such facilities as a way of driving store traffic. Thus, consumers who visit a photo kiosk within a retail store may often make ancillary purchases that would not have been made if the store did not offer a photo kiosk/digital minilab to draw the consumer into the store. While such purchases are useful to the retailer, these purchases are often random, impulse type purchases which occur while a consumer wanders past an item that “catches their eye” on the path to and from the kiosk.

It would be very advantageous to retailers if they would be able to gain an insight into the interests, characteristics and lifestyles of these drop-in kiosk consumers, so that they might target advertising of the store's goods and services to match the wants and needs of these consumers. The digital images that the consumer brings to the digital photo kiosks and digital minilabs for processing uniquely capture some of these interests, characteristics and lifestyles. It would be highly beneficial to the retailer to harvest the wealth of information present in these digital images in order to present the consumer with merchandise uniquely tailored to their interests, characteristics and lifestyles.

### SUMMARY OF THE INVENTION

The present invention provides an apparatus (e.g., a photo kiosk or digital minilab) having at least one processor coupled to a memory, with at least one digital image residing in the memory. An advertising generator also resides in the memory, and is executed by the processor(s). The advertising generator analyzes a selected digital image for one or more consumer identifying characteristics, and generates an advertisement targeted to a consumer based on the consumer identifying characteristic(s). The generated advertisement may take a variety of forms, including but not limited to: an on-screen display at the photo kiosk, a custom generated coupon, or a photo jacket insert.

The analysis of the selected digital image for one or more consumer identifying characteristics can be performed in several ways. In one embodiment, the analysis is done by performing object recognition of at least one defined object within the selected digital image. In another embodiment, the analysis is done by performing text recognition within the selected digital image. In yet another embodiment, the analysis is done by reading metadata associated with the selected digital image.

The present invention also provides a method for advertising to a consumer based on the content of a digital image associated with the consumer. The method begins by analyzing the digital image for one or more consumer identifying characteristics. Next, an advertisement is generated which is targeted to the consumer based on the one or more consumer identifying characteristics. In one embodiment, the analysis step is done by performing object recognition of at least one defined object within the digital image. In another embodiment, the analysis step is done by performing text recognition within the digital image. In yet another embodiment, the analysis is done by reading metadata associated with the digital image.

In one embodiment of the present invention, the generation of the targeted advertisement includes the steps of creating a mapping from a plurality of potential consumer identifying characteristics to at least one associated advertisement. Next, if at least one consumer identifying characteristic exists within the digital image, at least one associated advertisement is identified to display to the consumer via the mapping. Finally, the at least one associated advertisement is presented to the consumer, in the form of an on-screen display at the photo kiosk, a printed coupon, or via other advertising media.

The present invention also provides a program product having an advertising generator that analyzes a selected digital image for one or more consumer identifying characteristics, and generates an advertisement target to a consumer based on the one or more consumer identifying characteristics. The program product further includes a computer-readable signal bearing media bearing the advertising generator. The computer-readable signal bearing media may take the form of recordable media and/or transmission media.

The foregoing and other features and advantages of the invention will be apparent from the following more particular description of preferred embodiments of the invention, as illustrated in the accompanying drawings.

### BRIEF DESCRIPTION OF THE DRAWINGS

FIG. 1 is a block diagram of an apparatus for analyzing a digital image for one or more consumer identifying characteristics, and generating an advertisement targeted to a consumer based on the consumer identifying characteristic(s).

FIG. 2 is an illustration of a digital image containing recognizable objects, text and metadata.

FIG. 3 is a table illustrating relationships between consumer identifying characteristics and advertisements tailored to the consumer identifying characteristics.

FIG. 4 is a flowchart of a method for advertising to a consumer based on the content of a digital image associated with the consumer.

### DETAILED DESCRIPTION OF THE PREFERRED EMBODIMENTS

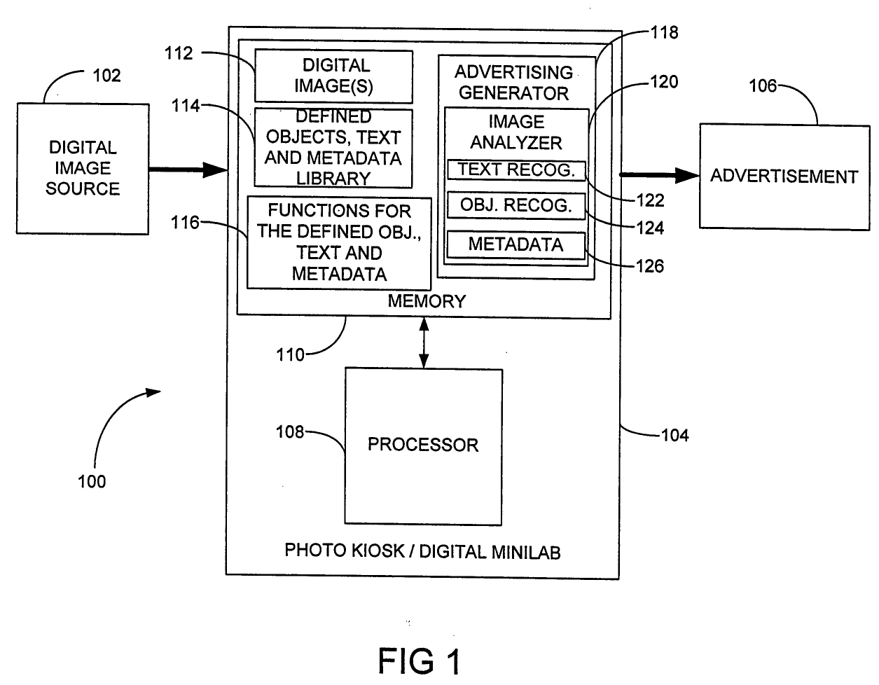

Turning to the Drawings, wherein like numbers denote like parts throughout the several views, FIG. 1 is a block diagram of an apparatus for analyzing a digital image for one or more consumer identifying characteristics, and generating an advertisement targeted to a consumer based on the consumer identifying characteristic(s).

As shown in FIG. 1, a system 100 in accordance with the preferred embodiments includes a digital image source 102 coupled to a photo kiosk/digital minilab 104 (hereinafter collectively referred to as photo kiosk). Photo kiosk 104 generates advertisements 106 tailored to specific consumer identifying characteristics identified in digital image source 102. Digital image source 102 may be a digital camera, or may be a repository of digital images (such as a flash memory card, floppy disk or a hard drive), and is intended in its broadest sense to include any suitable source of digital images. Advertisements 106 generated by photo kiosk 104 may take on a variety of forms including, but not limited to: a screen advertisement on the display of the photo kiosk, a printed coupon, and/or a photo jacket insert.

Digital image source 102 may be transferred to the photo kiosk 104 in a variety of ways. In one embodiment, a flash memory card containing one or more digital images is plugged into a slot in the photo kiosk 104, and the digital image source is read into one or more digital images 112 residing within memory 110 of the photo kiosk. In another embodiment, digital images 112 contained within a portable device carried by a consumer are transmitted to the photo kiosk 104 via wireless means. In yet another embodiment, digital images 112 are transferred from a consumer's home computer to the photo kiosk 104 via the internet. In another embodiment, the digital image source 102 is created at the photo kiosk 104 itself by scanning (via an image scanner) an existing paper photograph at the photo kiosk 104, then converting the scanned paper photograph into one or more digital images 112 stored in memory 110 of the photo kiosk. In addition to these embodiments, it is anticipated that digital image source 102 may be created/transferred to photo kiosk 104 via additional means and still remain within the scope and spirit of the present invention.

Photo kiosk 104 includes a processor 108 coupled to memory 110. Memory 110 includes an advertising generator 118 which is executed by processor 108. In a preferred embodiment, advertising generator 118 is a computer program. Advertising generator 118 includes an image analyzer 120, which analyzes digital images 112 for recognizable features. Image analyzer 120 includes text recognition logic 122, object recognition logic 124, and metadata recognition logic 126 that determine when known objects, text and metadata reside, respectively, within digital image 112. Advertising generator 118 compares a set of objects, text and metadata identified within digital images 112 against a library of predefined objects, text and metadata 114. In addition to the predefined objects, text and metadata 114, there are also one or more defined functions 116 that correspond to the recognized predefined objects, text, and metadata 114. Thus, when the advertising generator 118 recognizes any predefined text, objects and metadata contained in library 114 within the digital image(s) 112, the predefined functions 116 that correspond to the recognized object, text and/or metadata are performed.

As an example, digital image 112 may contain an image of a dog. Advertising generator 118 compares the object of the dog against the collection of objects contained within library 114. If a match is found (i.e., it is determined that a dog object exists within digital image 112), a function 116 is run which generates an ad specifically tailored to dog owners.

Much work has been done in the art regarding text and object recognition within digital images. One example of this is piXlogic's virtual search engine. PiXlogic's software analyzes an image, and identifies logical visual “objects” within the image. It stores detailed information about these objects (for example the shape, the color, the position, the orientation, the size, etc. in the image) and does so in a compact mathematical format. Another example of known recognition logic is Content-based Image Retrieval (CBIR), discussed in detail in a report at: www.northumbria.com/iidr/research/cbir/report.html.

Some other examples of object recognition include: determining a person's gender with face recognition—(L. Wiskott, J.-M. Fellous, N. Kruger, C. von der Malsburg, “Face Recognition and Gender Determination” in Proceedings of the International Workshop on Automatic Face—and Gesture recognition. Zurich 1995); determining product logos—D. Doermann, E. Rivlin, and I. Weiss, “Logo recognition using geometric invariants,” in Proceedings of the Second International Conference on Document Analysis and Recognition, pp. 894-897, Tsukuba, Japan, 1993; and determining the breed of a dog—(Deep Vision Inc.'s Perceptify product (www.deepvision.ca/sol_overview.html)).

Digital watermarking technology is a well-known technique for hiding or embedding information (such as metadata) within a digital image. The embedded information (such as the photographer's name, location, and photograph characteristics) is invisible. However, it can be detected or extracted with special computer routines. The information in a digital watermark can indicate the origin of a digital picture. It also can function as a label that “tells” computer programs (or other digital files) whether and how to use that picture. Digital watermarking is discussed in: S. J. Daly, J. R. Squilla, M. Denber, C. W. Honsinger, and J. Hamilton, “Method for Embedding Digital Information in an Image”, U.S. Pat. No. 5,859,920, 1999. It is anticipated that other methods in addition to digital watermarking may be employed to embed metadata and other interesting consumer characteristic information within digital image files, and that such methods would still remain within the scope and spirit of the present invention.

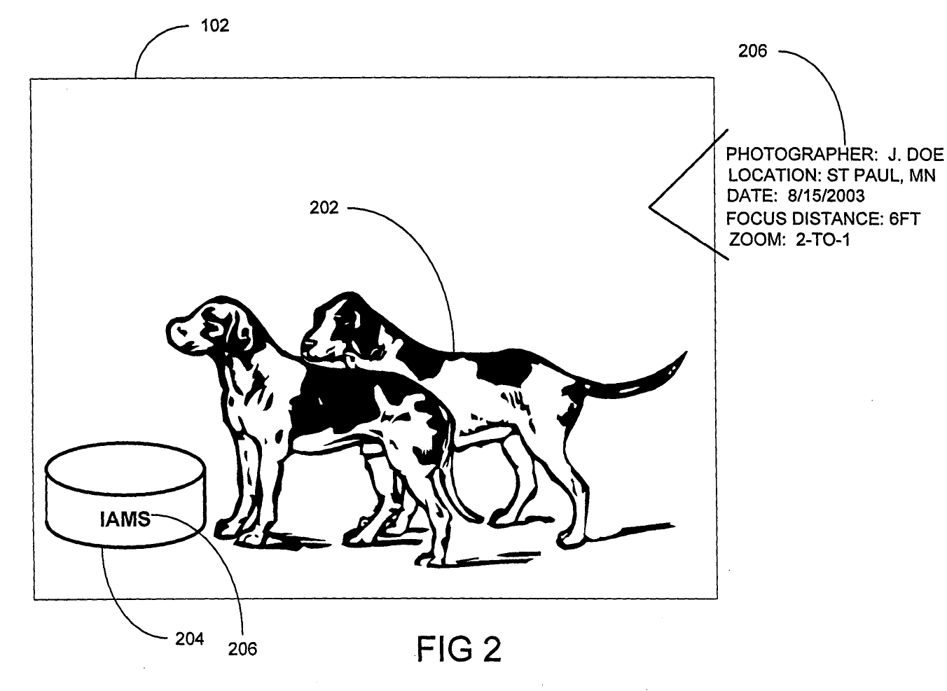

FIG. 2 is an illustration of a digital image containing recognizable objects, text and metadata in the form of a digital watermark. In the illustrated digital image 112, two dogs 202 are pictured next to a dog bowl 204 bearing the name of a dog food manufacturer “IAMS” 206. The digital image also includes metadata 206 incorporated within the image providing the name of the photographer, the location of the photograph, the date the photograph was taken, the focus distance, and the zoom ratio used to take the photograph. In the illustrated embodiment, a digital watermark is used to embed the metadata within the image.

In this instance, the image analyzer component of advertising generator (FIG. 1, element 118) detects any recognizable objects by comparing any objects, text and/or metadata present within digital image 112 against the predefined objects, text and metadata 114. If one or more objects, text or metadata are recognized within the digital image 112, functions associated with the defined objects, text and metadata 116 are run.

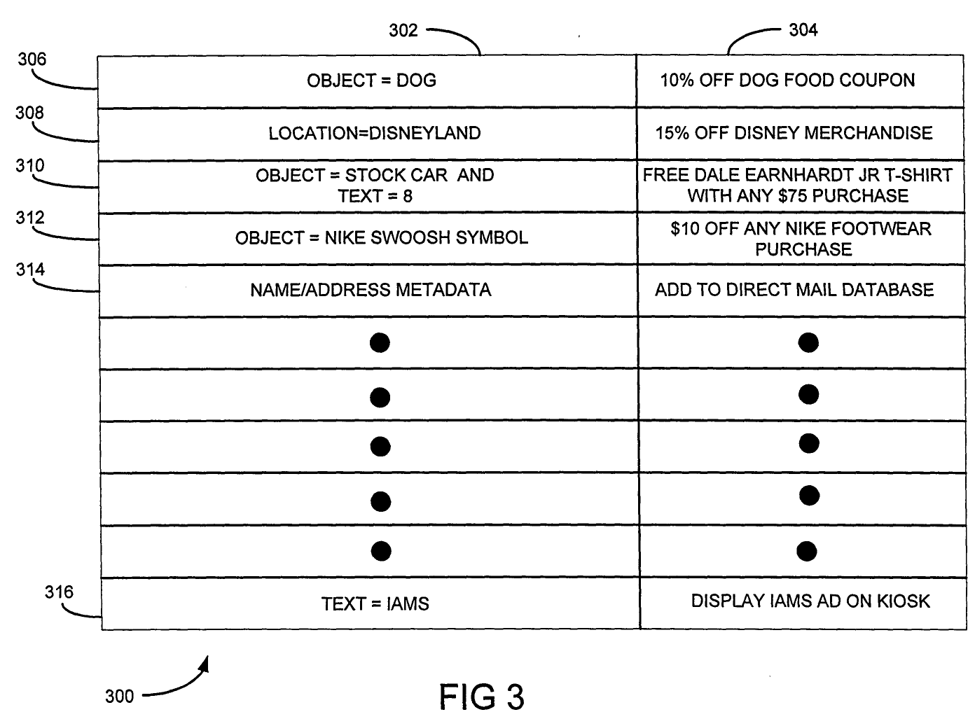

FIG. 3 is a table illustrating relationships between recognized consumer identifying characteristics (i.e., objects, text and metadata present in digital image 112 which match any items in the predefined library of objects, text and metadata 114) and functions 116 which generate advertisements tailored to the consumer identifying characteristics, shown generally at 300. The first column 302 of the table 300 indicates the recognized identifying characteristic(s) and the second column 304 of the table 300 indicates an associated function (i.e. generating of an advertisement).

For example, line 306 of the table indicates that if the image analyzer of the advertising generator detects a dog within the digital image 112, an associated function 116 is run which generates a coupon for 10% off dog food. At line 308, if metadata is contained within digital image 112 which indicates that the digital photograph was taken at Disneyland (i.e., determined by either by text or GPS locational coordinates), an advertisement is generated which provides the consumer a coupon for 15% off Disney merchandise.

The present invention also contemplates the capability to combine the identification of multiple objects, text and metadata within digital image 112 to generate an advertisement. For example, at line 310 of the table, digital image 112 contains a stock car and also text with the number “8”. Since the driver of the number 8 stock car in NASCAR auto racing is a popular and well known driver (i.e., Dale Earnhardt Jr.), it is a reasonable assumption that the consumer taking such a photograph would have a special interest in Dale Earnhardt Jr./NASCAR merchandise. Thus, if the combination of a “stock car” and the number “8” is identified within a digital image, an advertisement may be generated at the photo kiosk which provides a free Dale Earnhardt Jr. T-Shirt with an $75 purchase at the merchant's location.

The present invention can also be used to identify specific branding logos within a digital image. For example, at line 312, a relationship is established within the table which defines that when a NIKE “swoosh” logo object is identified within a digital image 112, an associated function 116 is run to generate a coupon for $10 off any Nike footwear purchase.

The present invention can also utilize consumer information within the metadata of the digital image to develop a database of information on a consumer. At 314, the digital image 112 contains information on a consumer, including their name and address. If this information is identified by the image analyzer 120 component of the advertising generator, it would be possible for a merchant to build up a direct mail database of consumers, or even an e-mail distribution list. With this information, the merchant can distribute tailored advertisements to the consumer based on the consumer identifying characteristics captured by the advertising generator 118. By knowing the name of the consumer, merchants can also create coupons and other advertisements which are addressed specifically to the holder of the coupon.

It is anticipated that advertising generator 118 employs some selectivity on the quantity and type of advertisements presented to the consumer. As an example, if a consumer brings a large number digital images 112 containing dogs to photo kiosk 104, the consumer is not presented with a large number of identical coupons. Similarly, if a large number of objects, text or metadata from a set of digital images 112 match objects, text and metadata within library 114, only a selected number of advertisements 106 are presented to the consumer.

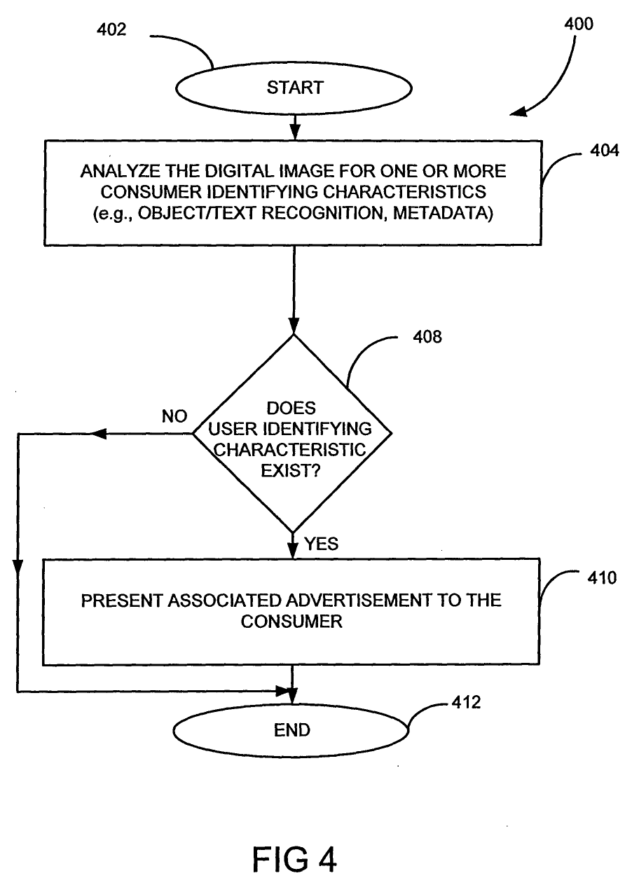

FIG. 4 is a flowchart of a method for advertising to a consumer based on the content of a digital image associated with the consumer, shown generally at 400. The method begins at block 402. At block 404, a digital image is analyzed for one or more consumer identifying characteristics (e.g., objects, text, and metadata). This is accomplished by having the image analyzer (FIG. 2, element 120) perform object recognition of a least one defined object within a digital image, performing text recognition within the digital image and/or reading metadata associated with the digital image. Next, at block 408, it is determined if at least one consumer identifying characteristic is identified within the digital image. If not, the method ends at block 412. If at least one consumer identifying characteristic is identified, one or more advertisement associated with the consumer identifying characteristic is presented to the consumer, as shown at block 410. In one embodiment, the advertisement is presented to the consumer by generating a screen display of the advertisement at the display of the photo kiosk. In yet another embodiment, one or more consumer coupons are printed at the photo kiosk corresponding to the associated advertisement. Finally, at block 412, the method ends.

One skilled in the art will appreciate that many variations are possible within the scope of the present invention. Thus, while the invention has been particularly shown and described with reference to preferred embodiments thereof, it will be understood by those skilled in the art that there and other changes in form and details may be made therein without departing from the spirit and scope of the invention.

1. An apparatus, comprising:
at least one processor;
a memory coupled to the at least one processor;
at least one digital image residing in the memory; and
an advertising generator residing in the memory and executed by the at least one processor, the advertising generator analyzing a selected digital image for one or more consumer identifying characteristics, and generating an advertisement targeted to a consumer based on the one or more consumer identifying characteristics.

2. The apparatus of claim 1, wherein the analyzing of the selected digital image for one or more consumer identifying characteristics involves object recognition of at least one defined object within the selected digital image.

3. The apparatus of claim 1, wherein the analyzing of the selected digital image for one or more consumer identifying characteristics involves text recognition within the selected digital image.

4. The apparatus of claim 1, wherein the analyzing of the selected digital image for one or more consumer identifying characteristics involves reading metadata associated with the selected digital image.

5. The apparatus of claim 1, wherein the apparatus is a photo kiosk.

6. The apparatus of claim 1, wherein the apparatus is a digital minilab.

7. The apparatus of claim 1, wherein the generated advertisement is a screen display.

8. The apparatus of claim 1, wherein the generated advertisement is a coupon.

9. The apparatus of claim 1, wherein the generated advertisement is a photo jacket insert.

10. A method for advertising to a consumer based on the content of a digital image associated with the consumer, the method comprising the steps of:
analyzing the digital image for one or more consumer identifying characteristics; and
generating an advertisement targeted to the consumer based on the one or more consumer identifying characteristics.

11. The method of claim 10, wherein the step of analyzing the digital image for one or more consumer identifying characteristics comprises the step of:
performing object recognition of at least one defined object within the digital image.

12. The method of claim 10, wherein the step of analyzing the digital image for one or more consumer identifying characteristics comprises the step of:
performing text recognition within the digital image.

13. The method of claim 10, wherein the step of analyzing the digital image for one or more consumer identifying characteristics comprises the step of:
reading metadata associated with the digital image.

14. The method of claim 10, wherein the step of generating an advertisement targeted to a consumer based on the one or more consumer identifying characteristics further includes the steps of:
creating a mapping from one or more potential consumer identifying characteristics to at least one associated advertisement.
if at least one consumer identifying characteristic exists within the digital image, identifying at least one associated advertisement to display to the consumer via the mapping; and
presenting the at least one associated advertisement to the consumer.

15. The method of claim 14, wherein the step of presenting the at least one associated advertisement to the consumer comprises the step of:
generating a screen display of the at least one associated advertisement.

16. The method of claim 14, wherein the step of presenting the at least one associated advertisement to the consumer comprises the step of:
printing one or more coupons corresponding to the at least one associated advertisement.

17. A program product comprising:
an advertising generator that analyzes a selected digital image for one or more consumer identifying characteristics, and generates an advertisement targeted to a consumer based on the one or more consumer identifying characteristics; and
computer-readable signal bearing media bearing the advertising generator.

18. The program product of claim 17 wherein the computer-readable signal bearing media comprises recordable media.

19. The program product of claim 17 wherein the computer-readable signal bearing media comprises transmission media.

20. The program product of claim 17 wherein the analyzing of the selected digital image for one or move consumer identifying characteristics involves object recognition of at least one defined object within the selected digital image.

21. The program product of claim 17 wherein the analyzing of the selected digital image for one or more consumer identifying characteristics involves text recognition within the selected digital image.

22. The program product of claim 17 wherein the analyzing of the selected digital image for one or more consumer identifying characteristics involves reading metadata associated with the selected digital image.
